(19) United States
(12) Patent Application Publication
(10) Pub. No.: US 2004/0153333 A1
(43) Pub. Date: Aug. 5, 2004

(54) Electronic quotation system and corresponding method and program

(76) Inventors: Yasuhiro Oshima, Nagano-ken (JP); Junji Suzuki, Nagano-ken (JP)

Correspondence Address: MARTINE & PENILLA, LLP, 710 LAKEWAY DRIVE, SUITE 170, SUNNYVALE, CA, 94085, US

(21) Appl. No.: 10/696,625

(22) Filed: Oct. 28, 2003

(30) Foreign Application Priority Data
Oct. 28, 2002 (JP) 2002-312683

(51) Int. Cl. G06F 17/60

(52) U.S. Cl. 705/1

(57) ABSTRACT

In response to a confirmation request of an electronic quotation with respect to a specified product sent from a client PC 50 via the Internet, an electronic quotation system 10 reads electronic quotation information including a product quote, a delivery date, and a valid period from a database 30, and determines whether the electronic quotation is still in the valid period or the valid period of the electronic quotation has already expired. When it is determined that the electronic quotation is still in the valid period, an electronic quotation window including an ‘Order’ button is sent back to the client PC 50. When it is determined that the valid period of the electronic quotation has already expired, on the other hand, an electronic quotation window including an ‘Update’ button for updating the electronic quotation, instead of the ‘Order’ button, is sent back to the client PC 50. The electronic quotation system 10 of the invention readily determines whether the electronic quotation is still in the valid period or the valid period of the electronic quotation has already expired. Even after expiration of the valid period, the arrangement of the invention does not require a client to re-enter the electronic quotation information all over again.

### BACKGROUND OF THE INVENTION

1. Field of the Invention

The present invention relates to an electronic quotation system and a corresponding method as well as to a corresponding program.

2. Description of the Prior Art

Various Web sites on the Internet have been proposed to make a quote of a product specified by a client or a quote of a product including one or multiple components specified by the client. One known example of such Web sites is ‘Online BTO’ (retrieved on Aug. 26, 2002), Internet <URL: http://www.epsondirect.co.jp/>. When receiving a quotation request for a specified product from a client, this Web site sends back the current status of a stock, the product specifications, the price, the delivery date, and the valid period with respect to the specified product to the client. The quote of the client's specified product is also given by telephone or by facsimile.

When the client wants to check the valid period of the product quote on the Internet, however, the prior art technique requires the client to search for the indication of the valid period or to check the calendar for the date of today. It is accordingly not easy for the client to determine whether the product quote is still in the valid period or the valid period of the product quote has already expired. Another drawback of the prior art technique is that re-entry of the quotation-related information all over again is required to gain the quote of the specified product, after expiration of the valid period.

### SUMMARY OF THE INVENTION

The object of the present invention is thus to provide an electronic quotation system that enables a client to readily determine whether a product quote is in a valid period or the valid period of the product quote has expired, as well as a corresponding electronic quotation method. The object of the invention is also to provide an electronic quotation system that does not require the client to re-enter electronic quotation information all over again even after expiration of the valid period, and a corresponding electronic quotation method. The object of the invention is further to provide a computer program that causes a computer to function as an electronic quotation system.

To achieve at least one of the above objects, an electronic quotation system of the present invention is a system that makes a quote of a product specified by a client, the electronic quotation system including: a product information storage module that stores product information of the specified product, which is updated appropriately; a product quote preparation module that prepares a product quote, based on the product information of the specified product, in response to receipt of a quotation request of the specified product; a valid period setting module that sets a valid period of the product quote; and a product quote transmission module that sends a window, which includes the product quote and an order option selection element selected by the client to order a specification of the product quote, to a sender of the quotation request in such a manner that the order option selection element is enabled as selectable when the product quote is in the valid period and the order option selection element is disabled as unselectable when the valid period of the product quote has expired.

The electronic quotation system of the invention prepares a product quote based on the product information, in response to a quotation request of a product specified by a client, and sets a valid period of the product quote thus prepared. The electronic quotation system then sends a window including the order option selection element, which is activated to order a specification of the product quote and is enabled as selectable or disabled as unselectable according to the valid period, to the sender of the quotation request. The enabled state or the disabled state of the order option selection element explicitly informs the client of the valid period of the product quote. The client can thus readily determine whether the product quote is still in the valid period or the valid period of the product quote has already expired.

In one preferable application of the electronic quotation system according to the invention, the product quote transmission module sends the window, which includes an update option selection element selected to update a specification of the product quote after expiration of the valid period, to the sender of the quotation request. The electronic quotation system of this application includes: an update quote preparation module that prepares an update quote based on the product information of the specified product, in response to receipt of an update request of the product quote by selection of the update option selection element included in the window after expiration of the valid period; and an update quote transmission module that sends the window including the update quote, instead of the product quote, to the sender of the quotation request.

The electronic quotation system of the invention including the update quote preparation module and the update quote transmission module may further include a delivery date specification module that specifies a delivery date of the specified product, based on the product information of the specified product. The product quote preparation module prepares the product quote including the delivery date of the specified product, which is specified by the delivery date specification module, in response to receipt of the quotation request of the specified product. The update quote preparation module prepares the update quote including an updated delivery date of the specified product, which is updated by the delivery date specification module, in response to receipt of the update request of the product quote.

The electronic quotation system of the invention including the update quote preparation module and the update quote transmission module may include: a stock check module that reads a current status of a stock with respect to the specified product from the product information storage module to check the stock; and a substitute product retrieval module that retrieves one or multiple substitute products, which are substitutable for the specified product, from the product information storage module, and in the electronic quotation system the update quote preparation module, when the stock check module determines that there is no stock of the specified product in response to the update request of the product quote, may create a list of the one or multiple substitute products, which are retrieved by the substitute product retrieval module as the substitutable for the specified product, instead of preparing the update quote, and the update quote transmission module may send the window that includes the list of the one or multiple substitute products, instead of the product quote, to the sender of the quotation request. In the electronic quotation system of this case: the quotation request of the specified product may include specification of at least one component of the specified product; the stock check module may read a current status of a stock with respect to the at least one specified component of the specified product from the product information storage module to check the stock; the substitute product retrieval module may retrieve one or multiple substitute components, which are substitutable for the at least one specified component of the specified product, from the product information storage module; the update quote preparation module, when the stock check module determines that there is no stock of the at least one specified component of the specified product in response to the update request of the product quote, may create a list of the one or multiple substitute components, which are retrieved by the substitute product retrieval module as the substitutable for the at least one specified component of the specified product, instead of preparing the update quote; and the update quote transmission module may send the window that includes the list of the one or multiple substitute components, instead of the at least one specified component of the specified product, to the sender of the quotation request.

The electronic quotation system of the invention including the update quote preparation module and the update quote transmission module may include: a stock check module that reads a current status of a stock with respect to the specified product from the product information storage module to check the stock; and a substitute product retrieval module that retrieves one or multiple substitute products, which are substitutable for the specified product, from the product information storage module, and in the electronic quotation system the update quote preparation module, when the stock check module determines that there is no stock of the specified product in response to the update request of the product quote, may prepare a substitute product quote, based on product information on the one or multiple substitute products, which are retrieved by the substitute product retrieval module as the substitutable for the specified product, instead of preparing the update quote, and the update quote transmission module may send the window that includes the substitute product quote, instead of the product quote, to the sender of the quotation request. In the electronic quotation system of this case: the quotation request of the specified product may include specification of at least one component of the specified product; the stock check module may read a current status of a stock with respect to the at least one specified component of the specified product from the product information storage module to check the stock; the substitute product retrieval module may retrieve one or multiple substitute components, which are substitutable for the at least one specified component of the specified product, from the product information storage module; the update quote preparation module, when the stock check module determines that there is no stock of the at least one specified component of the specified product in response to the update request of the product quote, may prepare a substitute product quote, based on product information on the one or multiple substitute components, which are retrieved by the substitute product retrieval module as the substitutable for the at least one specified component of the specified product, instead of preparing the update quote; and the update quote transmission module may send the window that includes the substitute product quote, instead of the product quote, to the sender of the quotation request.

In the electronic quotation system of the present invention, the quotation request of the specified product may include specification of at least one component of the specified product.

In the electronic quotation system of the invention, the product quote transmission module may send a specific program, in addition to the window, to the sender of the quotation request, the specific program causing a computer at the sender of the quotation request to execute a function of enabling the order option selection element as selectable when the product quote is still in the valid period and disabling the order option selection element as unselectable when the valid period of the product quote has expired.

The electronic quotation system of the invention may further include a valid period judgment module that performs judgment of the valid period of the product quote at regular intervals or at irregular intervals, after transmission of the product quote by the product quote transmission module, and the product quote transmission module may send the window including an enabled state of the order option selection element to the sender of the quotation request when a result of the judgment by the valid period judgment module shows that the product quote is still in the valid period, while sending the window including a disabled state of the order option selection element to the sender of the quotation request when a result of the judgment by the valid period judgment module shows that the valid period of the product quote has already expired.

An electronic quotation method of the present invention is a method that causes a computer to make a quote of a product specified by a client by utilizing a product information storage module that stores product information of the specified product, which is updated appropriately, the electronic quotation method including the steps of: (a) causing the computer to prepare a product quote, based on the product information of the specified product, in response to receipt of a quotation request of the specified product; (b) causing the computer to set a valid period of the product quote; and (c) causing the computer to send a window, which includes the product quote and an order option selection element selected by the client to order a specification of the product quote, to a sender of the quotation request in such a manner that the order option selection element is enabled as selectable when the product quote is in the valid period and the order option selection element is disabled as unselectable when the valid period of the product quote has expired. Here, the computer may include only a single computer or multiple computers.

The electronic quotation method of the invention prepares a product quote based on the product information, in response to a quotation request of a product specified by a client, and sets a valid period of the product quote thus prepared. The electronic quotation method then sends a window including the order option selection element, which is activated to order a specification of the product quote and is enabled as selectable or disabled as unselectable according to the valid period, to the sender of the quotation request. The client can thus readily determine whether the product quote is still in the valid period or the valid period of the product quote has already expired.

In the electronic quotation method of the invention, the step(c) may cause the computer to send a window, which includes an update option selection element selected by the client to update the specification of the product quote after expiration of the valid period, to a sender of the quotation request, and the electronic quotation method of the invention may further include the steps of: (d) causing the computer, in response to receipt of an update request of the product quote by selection of the update option selection element in the window after expiration of the valid period, to prepare an update quote based on the product information of the specified product; and (e) causing the computer to send an updated window including the update quote, in place of the product quote, to the sender of the quotation request.

In the electronic quotation method of the invention including the step(d) and the step(e), the step(d) may cause the computer, in response to receipt of an update request of the product quote by selection of the update option selection element in the window after expiration of the valid period, to prepare an update quote including a delivery date based on the product information of the specified product.

In the electronic quotation method of the invention including the step(d) and the step(e), the step(d), in response to receipt of an update request of the product quote, may read a current status of a stock with respect to the specified product from the product information storage module, retrieve one or multiple substitute products, which are substitutable for the specified product, from the product information storage module when it is determined that there is no stock of the specified product, and create a list of the one or multiple substitute products, instead of preparing the update quote, and the step(e) may send the window including the list of the one or multiple substitute products, instead of the product quote, to the sender of the quotation request. In this case, the quotation request of the specified product may include specification of at least one component of the specified product, the step(d), in response to receipt of an update request of the product quote, may read a current status of a stock with respect to the at least one specified component of the specified product from the product information storage module, retrieve one or multiple substitute components, which are substitutable for the at least one specified component of the specified product, from the product information storage module when it is determined that there is no stock of the at least one specified component of the specified product, and create a list of the one or multiple substitute components, instead of preparing the update quote, and the step(e) may send the window including the list of the one or multiple substitute components, instead of the at least one specified component of the specified product, to the sender of the quotation request.

In the electronic quotation method of the invention including the step(d) and the step(e), the step(d), in response to receipt of an update request of the product quote, may read a current status of a stock with respect to the specified product from the product information storage module, retrieves one or multiple substitute products, which are substitutable for the specified product, from the product information storage module when it is determined that there is no stock of the specified product, and creates a substitute product quote, based on product information of the one or multiple substitute products instead of creating the update quote, and the step(e) may send the window including the substitute product quote, instead of the product quote, to the sender of the quotation request. In this case, the quotation request of the specified product may include specification of at least one component of the specified product, the step(d), in response to receipt of an update request of the product quote, may read a current status of a stock with respect to the at least one specified component of the specified product from the product information storage module, retrieve one or multiple substitute components, which are substitutable for the at least one specified component of the specified product, from the product information storage module when it is determined that there is no stock of the at least one specified component of the specified product, and create a substitute product quote, based on product information on the one or multiple substitute components, instead of creating the update quote.

In the electronic quotation method of the invention, the quotation request of the specified product may include specification of at least one component of the specified product.

In the electronic quotation method of the invention, the step(c) may send a specific program, in addition to the window, to the sender of the quotation request, the specific program causing a computer at the sender of the quotation request to execute a function of enabling the order option selection element as selectable when the product quote is still in the valid period and disabling the order option selection element as unselectable when the valid period of the product quote has expired.

An electronic quotation program of the present invention is a program that causes a computer to make a quote of a product specified by a client by utilizing a product information storage module that stores product information of the specified product, which is updated appropriately, the program causing the computer to attain the functions of: (a) preparing a product quote, based on the product information of the specified product, in response to receipt of a quotation request of the specified product; (b) setting a valid period of the product quote; and (c) sending a window, which includes the product quote and an order option selection element selected by the client to order a specification of the product quote, to a sender of the quotation request in such a manner that the order option selection element is enabled as selectable when the product quote is in the valid period and the order option selection element is disabled as unselectable when the valid period of the product quote has expired. The computer may include only a single computer or multiple computers.

The electronic quotation program of the invention may be recorded in a computer readable recording medium (for example, a hard disk, a ROM, an FD, a CD, or a DVD), may be transferred from one computer to another computer via a transfer medium (a communication network like the Internet or a LAN), or may be transmitted in any other suitable form. One single computer may execute this program, or alternatively multiple computers may share the functions of the program. Execution of the program prepares a product quote based on the product information, in response to a quotation request of a product specified by a client, and sets a valid period of the product quote. The program then sends a window including the order option selection element, which is activated to order a specification of the product quote and is enabled as selectable or disabled as unselectable according to the valid period, to the sender of the quotation request. The client can thus readily determine whether the product quote is still in the valid period or the valid period of the product quote has already expired.

### BRIEF DESCRIPTION OF THE DRAWINGS

FIG. 1 schematically illustrates the construction of an electronic quotation system 10 in one embodiment of the invention;

FIG. 2 shows information tables stored in a database;

FIG. 3 is a process chart showing a series of processing to issue of an electronic quotation;

FIG. 4 is a flowchart showing a product quote preparation routine;

FIG. 5 is a flowchart showing an electronic quotation submission routine;

FIG. 6 is a process chart showing a series of processing to issue of an updated electronic quotation;

FIG. 7 is a flowchart showing a valid period judgment routine;

FIG. 8 is a flowchart showing an updated electronic quotation submission routine;

FIG. 9 shows quotation information tables stored in the database;

FIG. 10 shows a quotation request window provided by the Web site;

FIG. 11 shows an electronic quotation window provided by the Web site;

FIG. 12 shows a list of substitute products provided by the Web site;

FIG. 13 shows a quotation request window with respect to a set of components selected by the client;

FIG. 14 shows the component information table stored in the database 30;

FIG. 15 shows electronic quotations including substitute product quotes provided by the Web site;

FIG. 16 shows a list of substitute components provided by the Web site; and

FIG. 17 shows one example of display to inform the client of the valid period of an electronic quotation.

### DESCRIPTION OF THE PREFERRED EMBODIMENTS

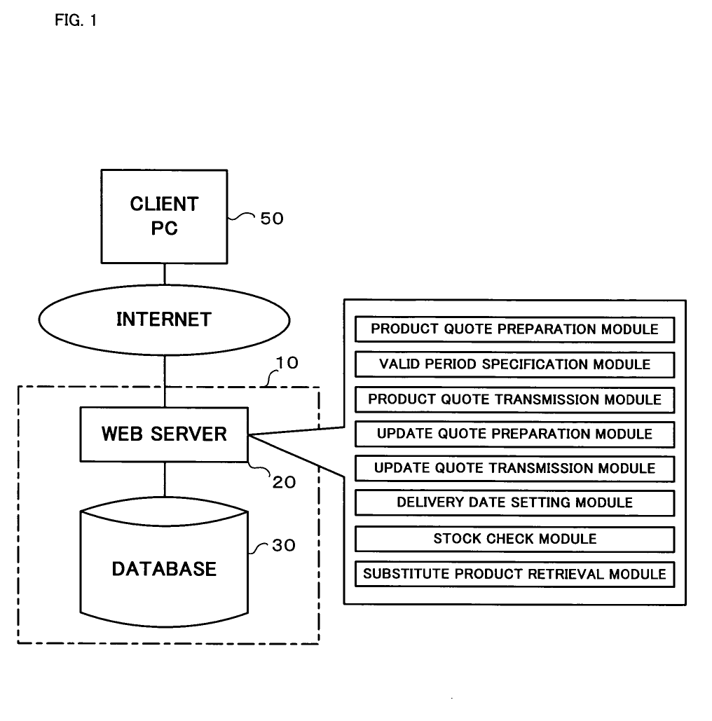

A preferred embodiment of the invention is discussed below with reference to the accompanied drawings. FIG. 1 schematically illustrates the construction of an electronic quotation system 10 in one embodiment of the invention.

The electronic quotation system 10 includes a Web server 20 that runs a Web site for selling and quoting personal computers and other computer products and a database 30 that is capable of storing various pieces of information. The Web server 20 and the database 30 are mutually connected via a communication line.

In response to receipt of a quotation request with respect to a specified product from a client PC 50 via the Internet, the Web server 20 functions to specify electronic quotation information representing a product quote (a specified product and its price), a delivery date, and a valid period, to register the specification of the electronic quotation information mapped to each client into the database 30, and to send a window (an electronic quotation) to the client PC 50. In response to an electronic quotation confirmation request from the client PC 50 via the Internet, the Web server 20 functions to determine whether the electronic quotation information read from the database 30 is in or out of the valid period and to send an electronic quotation according to a result of the determination to the client PC 50.

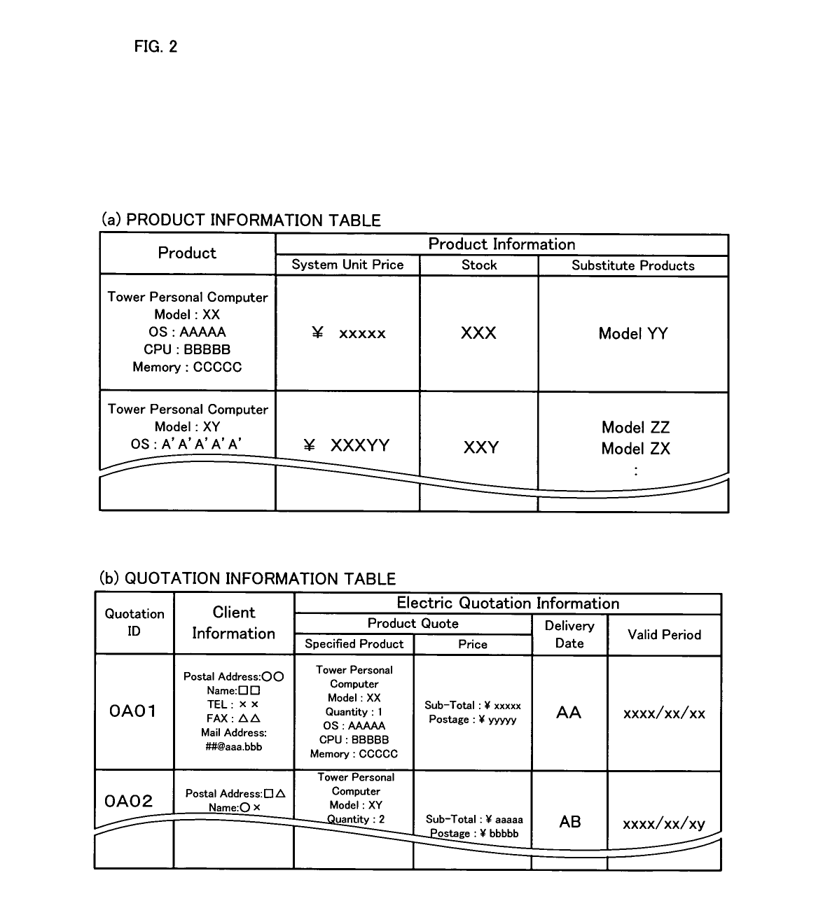

FIG. 2 shows a product information table and a quotation information table stored in the database 30. FIG. 2(a) shows the product information table, which represents mapping of each product and its components to product information including a price (system unit price), a stock, and substitute products. The contents of the product information table are appropriately updated by the Web server 20. Whenever one set of a certain product is sold at the Web site, the residual number of sets is specified as the current stock of the product. FIG. 2(b) shows the quotation information table in the database 30, which represents mapping of each quotation ID to client information including the name, the postal address, the telephone number, and the mail address of each client and to the electronic quotation information that includes the product quote, delivery date, and the valid period and is specified by the Web server 20. Here the quotation ID is allocated to each issue of an electronic quotation.

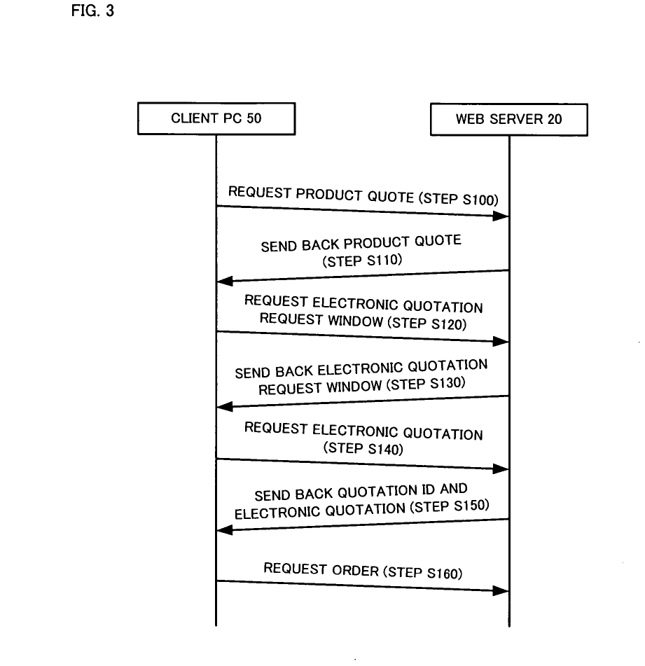

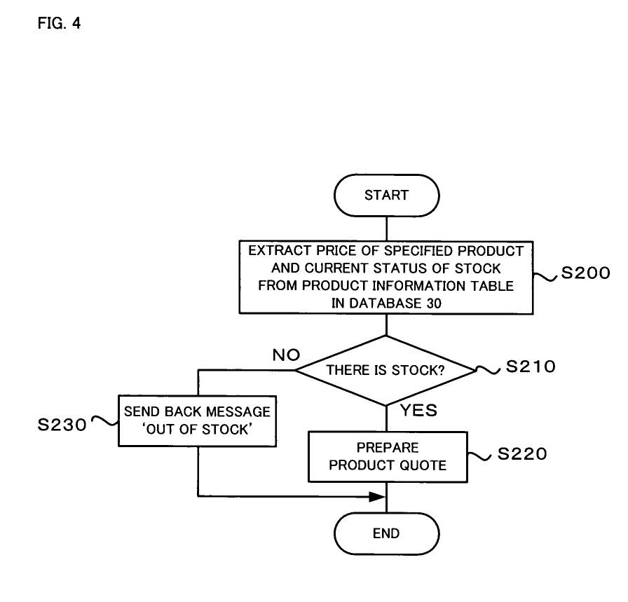

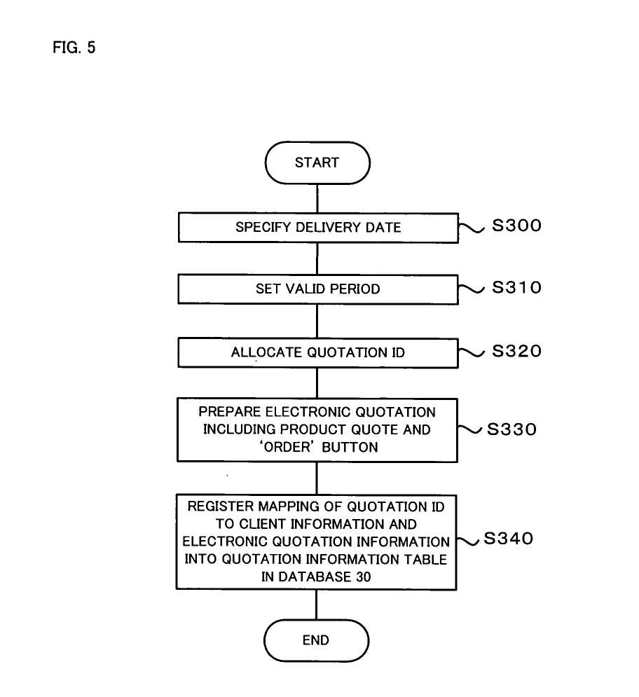

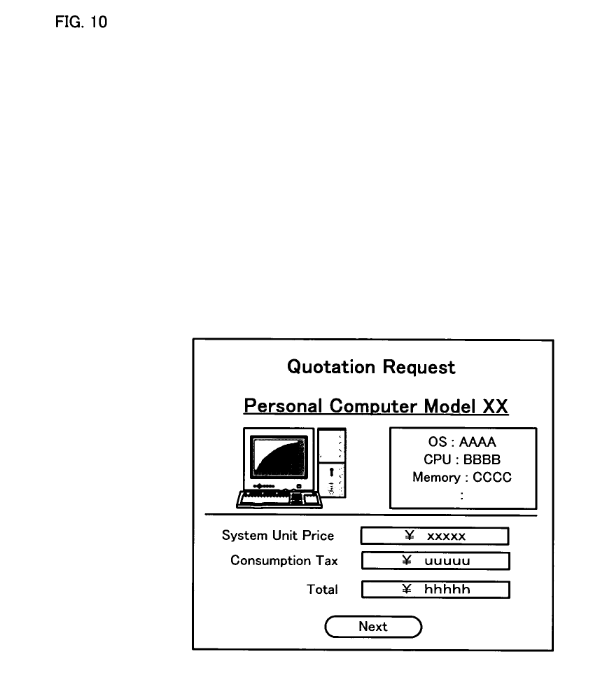

In the description below, it is assumed that the client operates the client PC 50 to give a quotation request with regard to a personal computer at the Web site run by the Web server 20. FIG. 3 is a process chart showing a series of processing to issue of an electronic quotation. FIG. 4 is a flowchart showing a product quote preparation routine executed by the Web server 20. FIG. 5 is a flowchart showing an electronic quotation submission routine executed by the Web server 20. In this example, the client selects one set of ‘tower personal computer, model XX’ as a specified product for a quotation request at this Web site. In response to the client's selection, the client PC 50 sends a request signal of product quote to the Web server 20 (step S100) as shown in the process chart of FIG. 3. When receiving the request signal of product quote, the Web server 20 extracts the price of the specified product and the current status of the stock from the product information table stored in the database 30 (step S200) and determines whether there is a stock (step S210), as shown in the flowchart of FIG. 4. When it is determined that there is a stock, the Web server 20 prepares a product quote according to the specified product and the extracted price (step S220). When it is determined at step S210 that there is no stock, on the other hand, the Web server 20 sends a message ‘Out of Stock’ to the client PC 50 (step S230). The program then exits from the product quote preparation routine of FIG. 4. On completion of the processing at step S220, the program goes back to the process chart of FIG. 3. The Web server 20 sends back the product quote thus prepared in the form of a quotation request window to the client PC 50 (step S110). FIG. 10 shows one example of the quotation request window open on the display of the client PC 50. Values in ‘System Unit Price’, ‘Consumption Tax’, and ‘Total Sum’ boxes in the quotation request window displayed on the client PC 50 are based on the transmitted product quote.

When the client clicks ‘Next’ in the quotation request window to require an electronic quotation request window (not shown) for entry of the client information, the client PC 50 sends a request signal of the electronic quotation request window to the Web server 20 (step S120). The Web server 20 then sends back the electronic quotation request window to the client PC 50 (step S130). The electronic quotation request window has an input field for entry of required pieces of information (including the client information) for preparation of an electronic quotation.

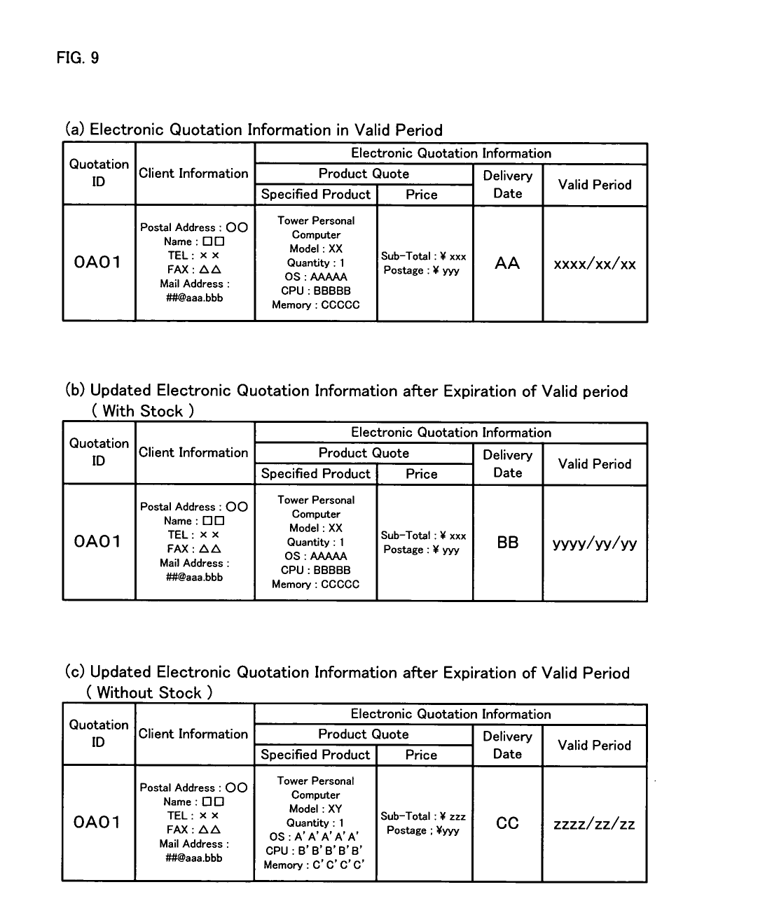

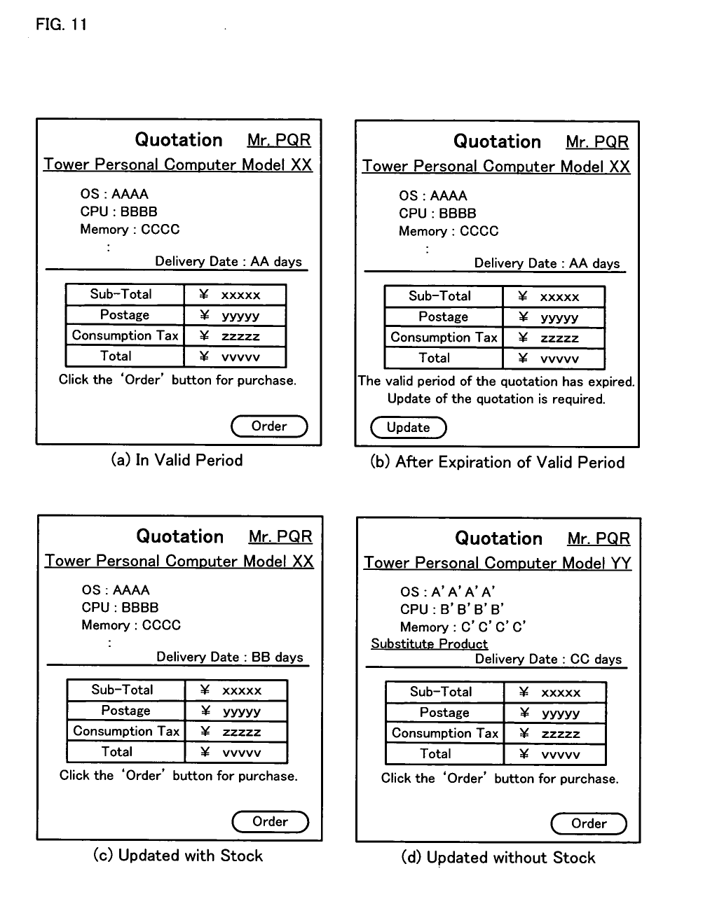

When the client enters the client information in the electronic quotation request window and clicks an ‘Electronic Quotation Request’ button, the client PC 50 sends a request signal of electronic quotation to the Web server 20 (step S140). The Web server 20 then specifies a delivery date according to the client information (the client's postal address) and the number of days required for assembly of the specified product (step S300) and sets a valid period (step S310). For example, one day from the quotation request date is set as the valid period. The Web server 20 subsequently allocates a quotation ID (for example, 0A01) to the client information and the electronic quotation information for the purpose of management (step S320). The Web server 20 prepares an electronic quotation including the product quote, the delivery date, and an ‘Order’ button (step S330), and registers the mapping of the quotation ID to the client information and the electronic quotation information into the quotation information table stored in the database 30 (step S340). FIG. 9(a) shows the contents of the registration in the database 30. On completion of the processing at step S340, the program returns to the process chart of FIG. 3 to send back the electronic quotation thus prepared to the client PC 50 (step S150). FIG. 11(a) shows an electronic quotation window open on the display of the client PC 50. When the client clicks the ‘Order’ button in the electronic quotation window, the client PC 50 sends a request signal of the order to the Web server 20 (step S160). The Web server 20 then shifts the processing to a purchase procedure of the specified product, which has been quoted in response to the client's request.

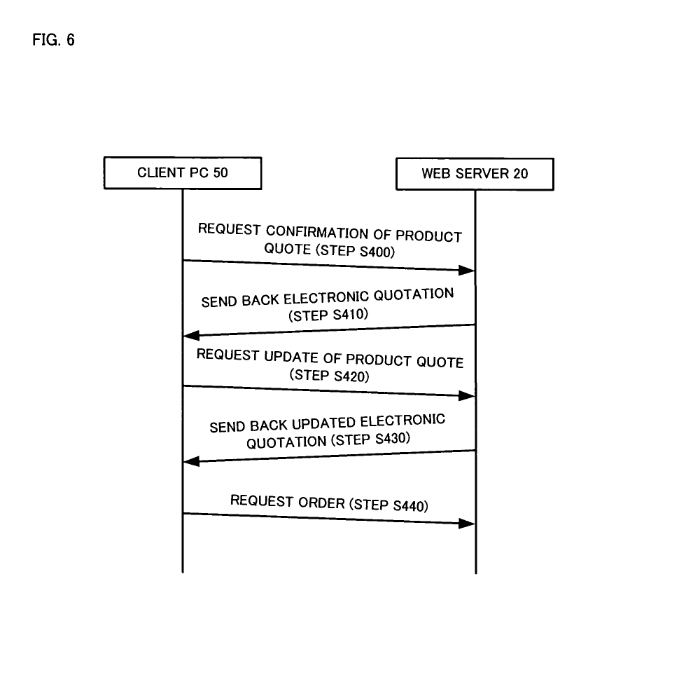

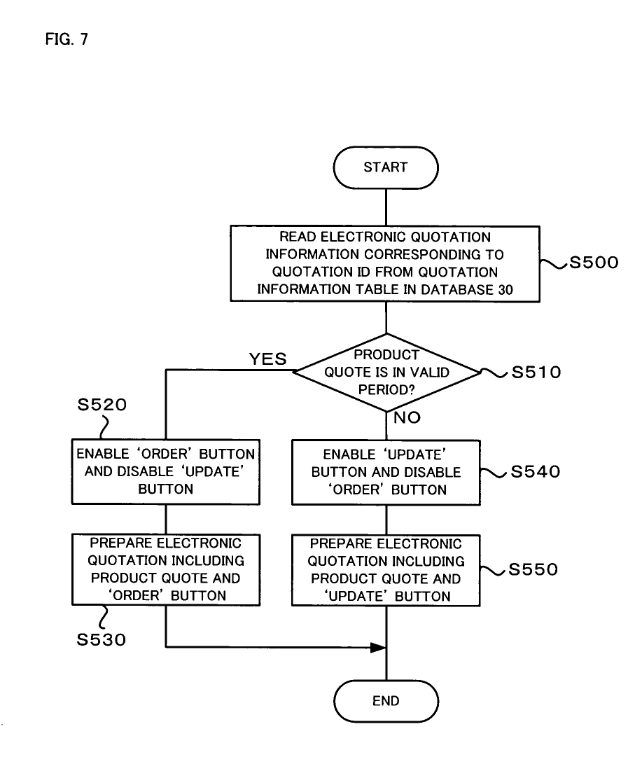

The client manipulates the client PC 50 to confirm the electronic quotation with respect to the set of personal computer, which has been quoted as the specified product, at the Web site run by the Web server 20. FIG. 6 is a process chart showing a series of processing to issue of an updated electronic quotation. FIG. 7 is a flowchart showing a valid period judgment routine executed by the Web server 20. When the client enters the allocated quotation ID (for example, 0A01) and clicks a ‘Confirm’ button in an electronic quotation confirmation window (not shown) to confirm the electronic quotation, the client PC 50 sends a request signal for confirmation of the product quote (step S400), as shown in the process chart of FIG. 6. The Web server 20 then reads the electronic quotation information mapped to the input quotation ID from the quotation information table stored in the database 30 (step S500), as shown in the flowchart of FIG. 7. The Web server 20 compares the valid period of the read-out product quote with the current time (that is, the time of the confirmation request) to determine whether the product quote is still in the valid period or the valid period of the product quote has already expired (step S510). When it is determined that the product quote is still in the valid period, the Web server 20 enables only an ‘Order’ button as selectable (step S520) and prepares an electronic quotation including the valid product quote of the read-out electronic quotation information and the ‘Order’ button (step S530). When it is determined at step S510 that the valid period of the product quote has already expired, on the other hand, the Web server 20 enables only an ‘Update’ button as selectable (step S540) and prepares an electronic quotation including the invalid product quote and the ‘Update’ button (step S550). On completion of the processing at either step S530 or step S550, the program goes back to the process chart of FIG. 6. The Web server 20 sends back the electronic quotation thus prepared to the client PC 50 (step S410). FIGS. 11(a) and 11(b) show examples of the electronic quotation window. FIG. 11(a) shows the window opening when the product quote is in the valid period, and FIG. 11(b) shows the window opening when the valid period of the product quote has expired.

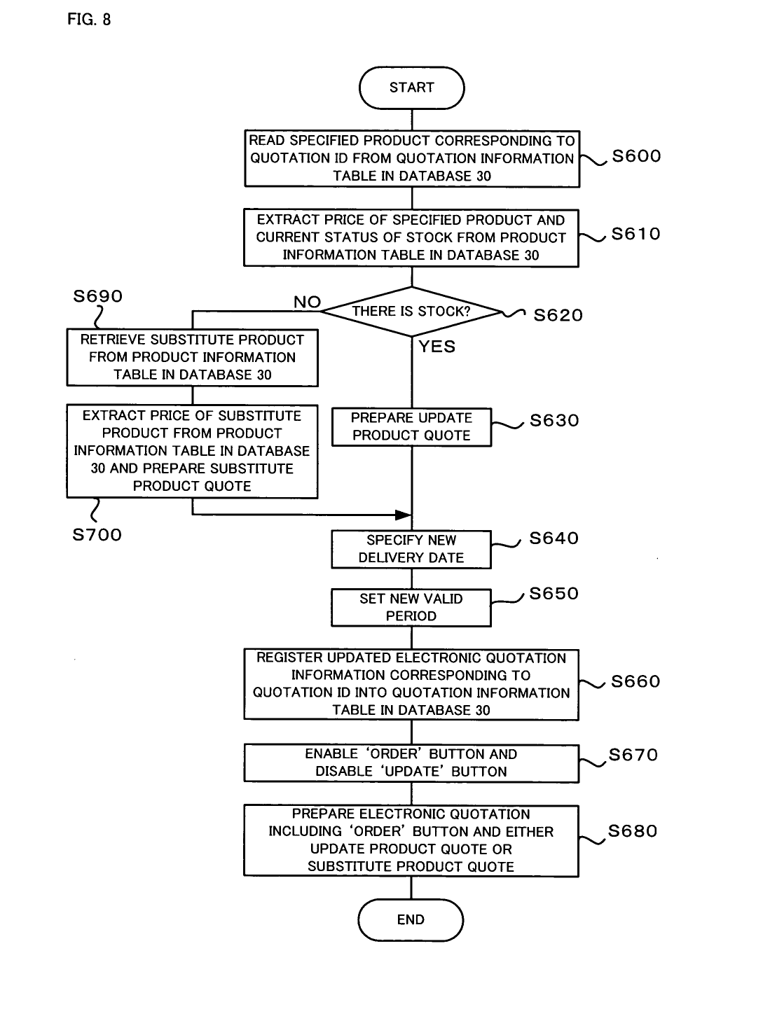

The client updates the electronic quotation by clicking the ‘Update’ button in the electronic quotation window shown in FIG. 11(b). FIG. 8 is a flowchart showing an updated electronic quotation submission routine executed by the Web server 20. When the client clicks the ‘Update’ button in the electronic quotation window shown in FIG. 11(b), the client PC 50 sends an update request to the Web server 20 (step S420), as shown in the process chart of FIG. 6. The Web server 20 receives the update request and reads the specified product corresponding to the input quotation ID from the quotation information table stored in the database 30 (step S600), as shown in the flowchart of FIG. 8. The Web server 20 subsequently extracts the price of the specified product and the current status of the stock from the product information table stored in the database 30 (step S610) and determines whether there is a stock (step S620). When it is determined that there is a stock, the Web server 20 prepares an update product quote, based on the currently extracted price of the specified product (step S630). When it is determined at step S620 that there is no stock, on the other hand, the Web server 20 retrieves any product substitutable for the specified product (substitute product) from the product information table of FIG. 2 stored in the database 30 (step S690), and extracts the price of the substitute product from the product information table stored in the database 30 and prepares a substitute product quote (step S700). For example, the Web server 20 retrieves one set of ‘tower personal computer, model YY’ as the substitute product at step S690 and prepares a substitute product quote based on the price of the substitute product extracted from the product information table stored in the database 30 at step S700. After the processing of either step S630 or step S700, the Web server 20 specifies a new delivery date according to the client's postal address and the number of dates required for assembly of the specified product or the substitute product (step S640) and sets a new valid period (step S650). For example, one day from the update request date is set as the valid period. The Web server 20 then registers the updated electronic quotation information corresponding to the quotation ID into the quotation information table stored in the database 30 (step S660). FIGS. 9(b) and 9(c) show the contents of the registration in the database 30. When there is a stock, the update product quote, instead of the product quote, is registered in the updated electronic quotation information shown in FIG. 9(b). When there is no stock, the substitute product quote, instead of the product quote, is registered in the updated electronic quotation information shown in FIG. 9(c). The Web server 20 enables only the ‘Order’ button as selectable (step S670) and prepares an electronic quotation including the ‘Order’ button and either the update product quote prepared at step S630 or the substitute product quote prepared at step S700 (step S680). After completion of the processing at step S680, the program goes back to the process chart of FIG. 6. The Web server 20 sends back the updated electronic quotation to the client PC 50 (step S430). FIGS. 11(c) and 11(d) show updated electronic quotation windows. FIG. 11(c) shows the window opening when there is a stock, and FIG. 11(d) shows the window opening when there is no stock.

When the client clicks the ‘Order’ button in the electronic quotation window, the client PC 50 sends an order request signal to the Web server 20 (step S440). The Web server 20 then shifts the processing to a purchase procedure of the specified product, which has been quoted in response to the client's request.

The respective constituents of this embodiment are mapped to the elements of the present invention. The database 30 of this embodiment corresponds to the product information storage module of the invention. The Web server 20 corresponds to the product quote preparation module, the product quote transmission module, the update quote preparation module, the update quote transmission module, the delivery date specification module, the stock check module, the substitute product retrieval module, and the valid period setting module. The ‘Order’ button and the ‘Update’ button of the embodiment respectively correspond to the order option selection element and the update option selection element.

In the structure of the embodiment discussed above, the Web server 20 prepares a product quote based on the product information stored in the database 30, in response to the client's quotation request of the specified product, sets the valid period of the product quote, and sends an electronic quotation including the ‘Order’ button, which is enabled as selectable or disabled as unselectable according to the valid period, to the client PC 50 of the client. The enabled state or the disabled state of the ‘Order’ button explicitly informs the client of the valid period of the electronic quotation. The client can thus readily determine whether the product quote is still in the valid period or the valid period of the product quote has already expired, based on the enabled state or the disabled state of the ‘Order’ button.

When the valid period of the product quote has already expired, the client obtains an updated electronic quotation including the update product quote by simply clicking the ‘Update’ button. This arrangement does not require the client to re-enter the specified product for a quotation request and thus desirably saves the time and the labor of the client.

The Web server 20 specifies the delivery date, based on the client information (the client's postal address) and the number of dates required for assembly of the client's specified product. The specified delivery date functions as an indication of when the specified product will be delivered to the client.

The Web server 20 checks the stock of the specified product based on the registration in the database 30. When there is no stock, the Web server 20 retrieves at least one substitute product, which substitutes for the specified product, from the database 30 and prepares a substitute product quote with respect to the substitute product. This arrangement gives the client an option for purchasing a product equivalent to the specified product. This arrangement also saves the client's labor and time for retrieving a substitute product and giving a quotation request of the substitute product.

The embodiment discussed above is to be considered in all aspects as illustrative and not restrictive. There may be many modifications, changes, and alterations without departing from the scope or spirit of the main characteristics of the present invention.

In the structure of the above embodiment, the Web server 20 carries out preparation of the electronic quotation and retrieval of the database 30, in addition to management of the Web site. In one possible modification, multiple servers may be used to share the respective functions. For example, the Web server 20 takes charge of management of the Web site, while another server takes charge of preparation of the electronic quotation and retrieval of the database 30.

In the structure of the above embodiment, the Web server 20 makes a judgment on the valid period. In one possible modification, a valid period judgment program, together with the electronic quotation, may be delivered to the client PC 50 in response to the quotation request. The client PC 50 can thus make a judgment on the valid period according to the delivered program without gaining access to the Web server. This modified arrangement also relieves the loading of access to the Web server 20. The valid period judgment function may be attained, for example, by a Java applet (where Java is the registered trademark by Sun Microsystems Inc.)

In the embodiment discussed above, the Web server 20 makes a judgment on the valid period in response to a request from the client PC 50. The judgment of the valid period may be made at regular intervals or at irregular intervals. This modification enables the Web server 20 to make a judgment on the valid period of the product quote at regular intervals or at irregular intervals, irrespective of the access from the client PC 50. For example, one application avoids the heavy-traffic time and intensively makes a judgment on the valid period in a light-traffic time. This ensures the efficient management of the Web server 20.

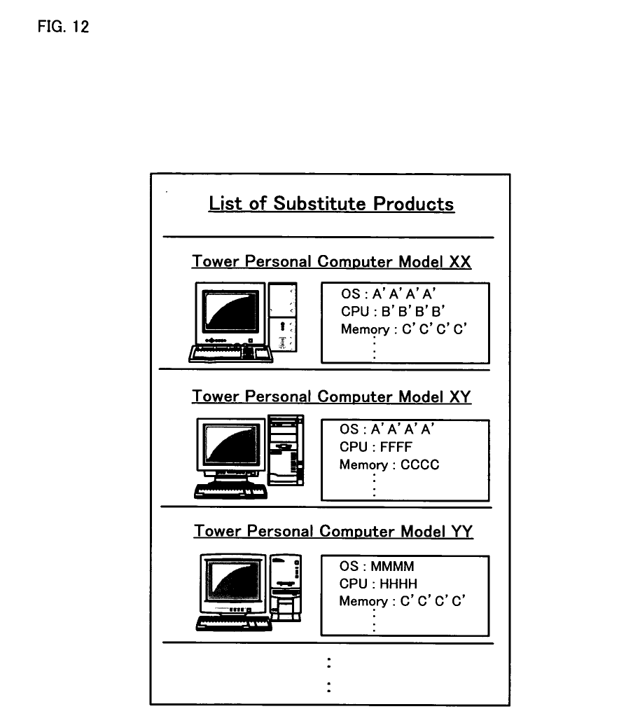

In the embodiment discussed above, when there is no stock of the specified product, the Web server 20 retrieves a substitute product, which substitutes for the specified product, and prepares a substitute product quote. One possible modification may send a list of substitute products to the client PC50, prior to preparation of the substitute product quote. This modified structure provides the client with a list of substitute products, which substitute for the specified product, when there is no stock of the specified product. This arrangement enables the client to select a substitute product equivalent to the specified product. FIG. 12 shows a list of substitute products provided by the Web site.

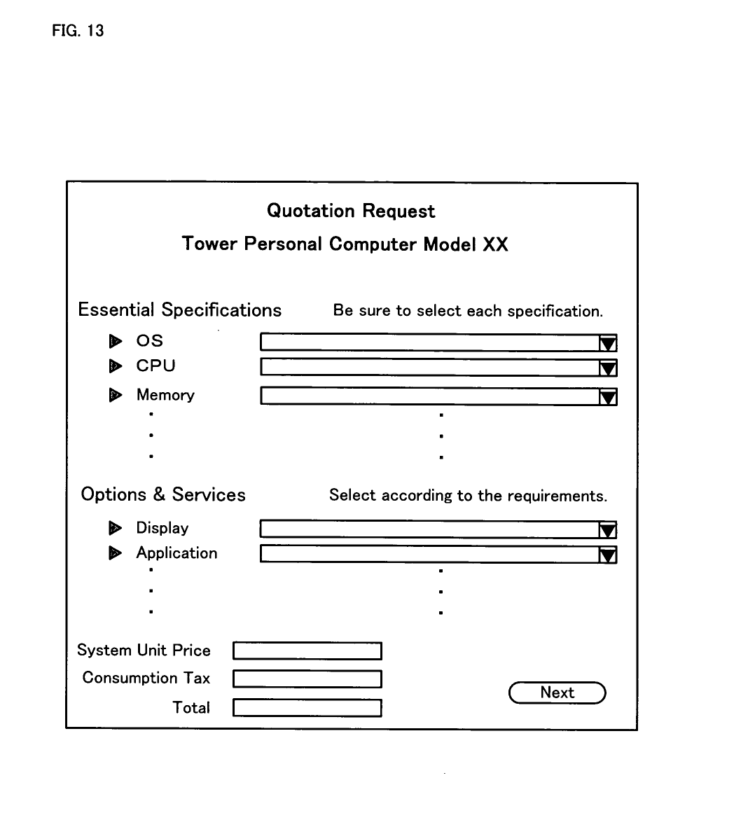

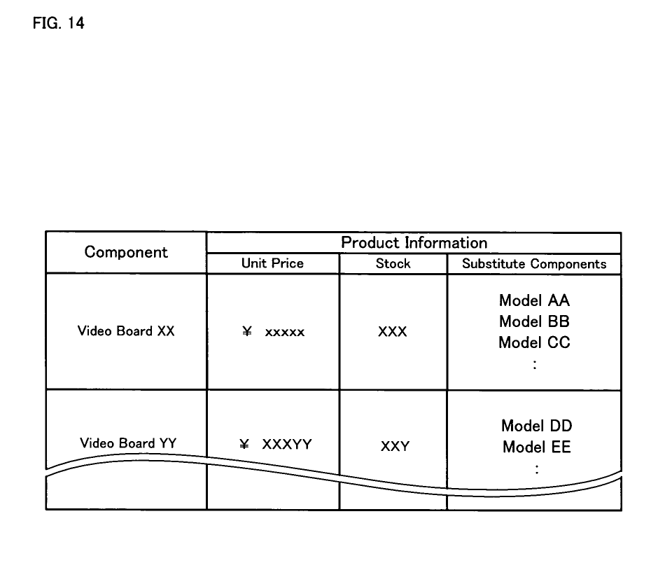

The procedure of the above embodiment prepares the electronic quotation with regard to the specified product, which is a made-up article by the manufacturer. One modified application may enable the client to select desired components for a made-to-order article. FIG. 13 shows a quotation request window to make a product quote with respect to a set of components selected by the client. In the example of FIG. 13, the client selects desired settings of ‘OS’, ‘CPU’, and ‘Memory’ as ‘Essential Specifications’ and ‘Display’ and ‘Application’ as ‘Options and Services’ from respective pull-down menus. This modified arrangement gives the client the electronic quotation of the made-to-order personal computer consisting of desired components. The system unit price of the set of personal computer is calculated by summing up the unit prices of the selected components. The delivery date of the personal computer is specified according to the client's postal address and the number of dates required for assembly of the made-to-order article by taking into account the availability of each component. The Web server 20 then sets the valid period (for example, one day from the request date of the electronic quotation) and prepares an electronic quotation of the specified made-to-order article. When there is no stock of any specified component, the Web server 20 retrieves one or multiple substitutable components for the specified component (substitute components) from a component information table stored in the database 30, extracts the price of each of the substitute components from the component information table, and prepares a product quote with respect to the made-to-order article including each of the substitute components. The Web server 20 specifies the delivery date of the made-to-order article including each of the substitute components, sets the valid period of the product quote, and prepares an electronic quotation. FIG. 14 shows the component information table stored in the database 30. For example, when there is no stock of ‘Video board, model XX’, the Web server 20 retrieves the component information table stored in the database 30, extracts substitute components that are substitutable for the specified component (for example, a video board, model YY and a video board, model ZZ), and prepares a product quote with respect to the made-to-order article including each of the substitute components.

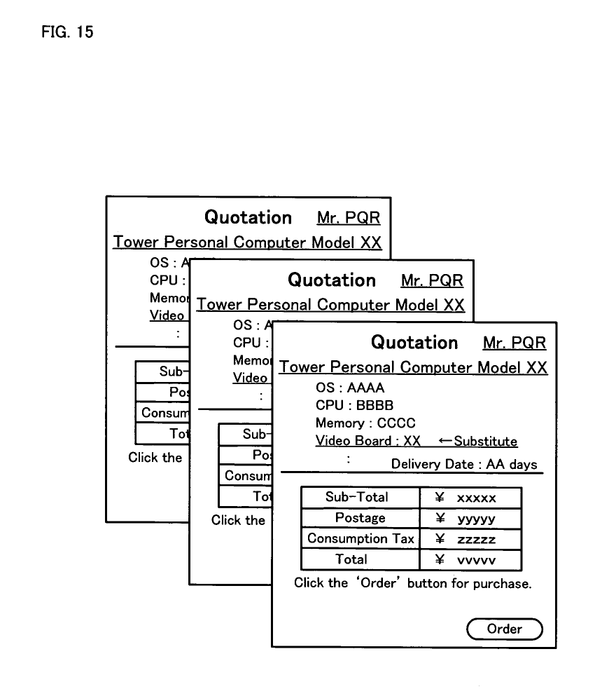

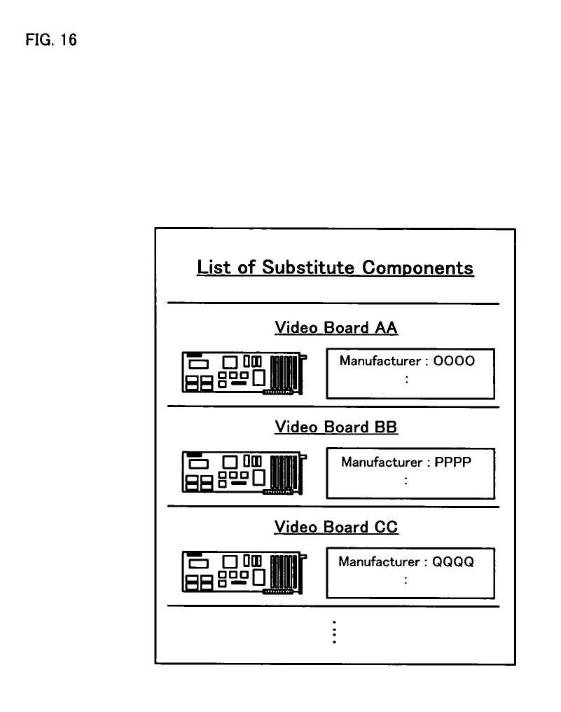

In the embodiment discussed above, the Web server 20 retrieves a made-up product by the manufacturer as a substitute product and prepares a substitute product quote. One modified application may retrieve a substitute component, which substitutes for the client's specified component, and prepare a substitute product quote with respect to a made-to-order article including the substitute component. This arrangement gives the client a substitute product quote with respect to the made-to-order article, which is equivalent to the client's selection. FIG. 15 shows electronic quotations including substitute product quotes. When there is no stock of a selected video board, for example, the Web server 20 retrieves substitute components and prepares substitute product quotes for the respective substitute components. FIG. 16 shows a list of substitute components provided by the Web site. The list of substitute components as shown in FIG. 16, instead of the substitute product quotes, may be sent to the client PC 50. This arrangement enables the client to select a desired substitute component equivalent to the originally selected component.

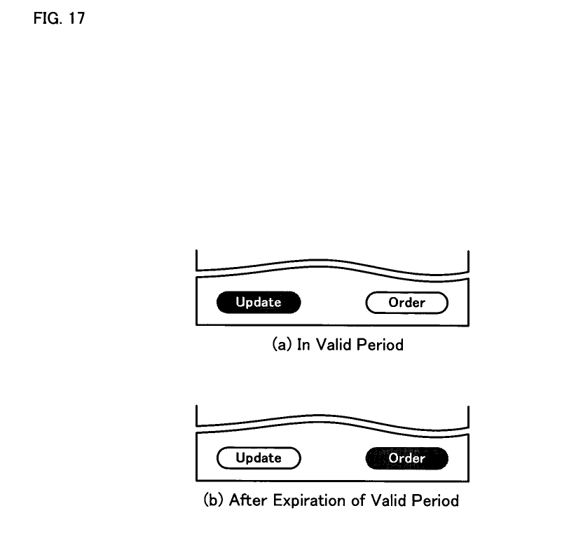

In the embodiment discussed above, the enabled state or the disabled state of the ‘Order’ button informs the client of the valid period. One possible modification may inform the client of the valid period by the enabled state or the disabled state of the ‘Update’ button. FIG. 17 shows one example of display to inform the client of the valid period of an electronic quotation. In the illustrated example of FIG. 17, the electronic quotation includes both the ‘Order’ button and the ‘Update’ button. The client readily determines that the electronic quotation is in the valid period according to the settings of the enabled state of the ‘Order’ button as selectable and the disabled state of the ‘Update’ button as unselectable (displayed in gray) as shown in FIG. 17(a). The client readily determines that the valid period of the electronic quotation has expired, on the other hand, according to the settings of the enabled state of the ‘Update’ button as selectable and the disabled state of the ‘Order’ button as unselectable (displayed in gray) as shown in FIG. 17(b).

What is claimed is:

1. An electronic quotation system that makes a quote of a product specified by a client, said electronic quotation system comprising:
a product information storage module that stores product information of the specified product, which is updated appropriately;
a product quote preparation module that prepares a product quote, based on the product information of the specified product, in response to receipt of a quotation request of the specified product;
a valid period setting module that sets a valid period of the product quote; and
a product quote transmission module that sends a window, which includes the product quote and an order option selection element selected by the client to order a specification of the product quote, to a sender of the quotation request in such a manner that the order option selection element is enabled as selectable when the product quote is in the valid period and the order option selection element is disabled as unselectable when the valid period of the product quote has expired.

2. An electronic quotation system that makes a quote of a product specified by a client, said electronic quotation system comprising:
a product information storage module that stores product information of the specified product, which is updated appropriately;
a product quote preparation module that prepares a product quote, based on the product information of the specified product, in response to receipt of a quotation request of the specified product;
a valid period setting module that sets a valid period of the product quote;
a product quote transmission module that sends a window, which includes the product quote, an order option selection element selected by the client to order a specification of the product quote, and an update option selection element selected by the client to update the specification of the product quote after expiration of the valid period, to a sender of the quotation request in such a manner that the order option selection element is enabled as selectable when the product quote is in the valid period and the order option selection element is disabled as unselectable when the valid period of the product quote has expired;
an update quote preparation module that, in response to receipt of an update request of the product quote by selection of the update option selection element in the window after expiration of the valid period, prepares an update quote based on the product information of the specified product; and
an update quote transmission module that sends an updated window including the update quote, in place of the product quote, to the sender of the quotation request.

3. An electronic quotation system in accordance with claim 2, said electronic quotation system further comprising:
a delivery date specification module that specifies a delivery date of the specified product, based on the product information of the specified product,
wherein said product quote preparation module prepares the product quote including the delivery date of the specified product, which is specified by said delivery date specification module, in response to receipt of the quotation request of the specified product, and
said update quote preparation module prepares the update quote including an updated delivery date of the specified product, which is updated by said delivery date specification module, in response to receipt of the update request of the product quote.

4. An electronic quotation system in accordance with claim 2, said electronic quotation system further comprising:
a stock check module that reads a current status of a stock with respect to the specified product from said product information storage module to check the stock; and
a substitute product retrieval module that retrieves one or multiple substitute products, which are substitutable for the specified product, from said product information storage module,
wherein said update quote preparation module, when said stock check module determines that there is no stock of the specified product in response to the update request of the product quote, creates a list of the one or multiple substitute products, which are retrieved by said substitute product retrieval module as the substitutable for the specified product, instead of preparing the update quote, and
said update quote transmission module sends the window that includes the list of the one or multiple substitute products, instead of the product quote, to the sender of the quotation request.

5. An electronic quotation system in accordance with claim 4, wherein the quotation request of the specified product includes specification of at least one component of the specified product,
said stock check module reads a current status of a stock with respect to the at least one specified component of the specified product from said product information storage module to check the stock,
said substitute product retrieval module retrieves one or multiple substitute components, which are substitutable for the at least one specified component of the specified product, from said product information storage module,
when said stock check module determines that there is no stock of the at least one specified component of the specified product in response to the update request of the product quote, said update quote preparation module creates a list of the one or multiple substitute components, which are retrieved by said substitute product retrieval module as the substitutable for the at least one specified component of the specified product, instead of preparing the update quote, and
said update quote transmission module sends the window that includes the list of the one or multiple substitute components, instead of the at least one specified component of the specified product, to the sender of the quotation request.

6. An electronic quotation system in accordance with claim 2, said electronic quotation system further comprising:
a stock check module that reads a current status of a stock with respect to the specified product from said product information storage module to check the stock; and
a substitute product retrieval module that retrieves one or multiple substitute products, which are substitutable for the specified product, from said product information storage module,
wherein said update quote preparation module, when said stock check module determines that there is no stock of the specified product in response to the update request of the product quote, prepares a substitute product quote, based on product information on the one or multiple substitute products, which are retrieved by said substitute product retrieval module as the substitutable for the specified product, instead of preparing the update quote, and
said update quote transmission module sends the window that includes the substitute product quote, instead of the product quote, to the sender of the quotation request.

7. An electronic quotation system in accordance with claim 6, wherein the quotation request of the specified product includes specification of at least one component of the specified product,
said stock check module reads a current status of a stock with respect to the at least one specified component of the specified product from said product information storage module to check the stock,
said substitute product retrieval module retrieves one or multiple substitute components, which are substitutable for the at least one specified component of the specified product, from said product information storage module, and
said update quote preparation module, when said stock check module determines that there is no stock of the at least one specified component of the specified product in response to the update request of the product quote, prepares a substitute product quote, based on product information on the one or multiple substitute components, which are retrieved by said substitute product retrieval module as the substitutable for the at least one specified component of the specified product, instead of preparing the update quote.

8. An electronic quotation system in accordance with claim 1, wherein the quotation request of the specified product includes specification of at least one component of the specified product.

9. An electronic quotation system in accordance with claim 1, wherein said product quote transmission module sends a specific program, in addition to the window, to the sender of the quotation request, said specific program causing a computer at the sender of the quotation request to execute a function of enabling the order option selection element as selectable when the product quote is still in the valid period and disabling the order option selection element as unselectable when the valid period of the product quote has expired.

10. An electronic quotation system in accordance with claim 1, said electronic quotation system further comprising:
a valid period judgment module that performs judgment of the valid period of the product quote at regular intervals or at irregular intervals, after transmission of the product quote by said product quote transmission module,
wherein said product quote transmission module sends the window including an enabled state of the order option selection element to the sender of the quotation request when a result of the judgment by said valid period judgment module shows that the product quote is still in the valid period, while sending the window including a disabled state of the order option selection element to the sender of the quotation request when a result of the judgment by said valid period judgment module shows that the valid period of the product quote has already expired.

11. An electronic quotation method that causes a computer to make a quote of a product specified by a client by utilizing a product information storage module that stores product information of the specified product, which is updated appropriately, said electronic quotation method comprising the steps of:
(a) causing the computer to prepare a product quote, based on the product information of the specified product, in response to receipt of a quotation request of the specified product;
(b) causing the computer to set a valid period of the product quote; and
(c) causing the computer to send a window, which includes the product quote and an order option selection element selected by the client to order a specification of the product quote, to a sender of the quotation request in such a manner that the order option selection element is enabled as selectable when the product quote is in the valid period and the order option selection element is disabled as unselectable when the valid period of the product quote has expired.

12. An electronic quotation method that causes a computer to make a quote of a product specified by a client by utilizing a product information storage module that stores product information of the specified product, which is updated appropriately, said electronic quotation method comprising the steps of:
(a) causing the computer to prepare a product quote, based on the product information of the specified product, in response to receipt of a quotation request of the specified product;
(b) causing the computer to set avalid period of the product quote;
(c) causing the computer to send a window, which includes the product quote, an order option selection element selected by the client to order a specification of the product quote, and an update option selection element selected by the client to update the specification of the product quote after expiration of the valid period, to a sender of the quotation request in such a manner that the order option selection element is enabled as selectable when the product quote is in the valid period and the order option selection element is disabled as unselectable when the valid period of the product quote has expired;
(d) causing the computer, in response to receipt of an update request of the product quote by selection of the update option selection element in the window after expiration of the valid period, to prepare an update quote based on the product information of the specified product; and
(e) causing the computer to send an updated window including the update quote, in place of the product quote, to the sender of the quotation request.

13. An electronic quotation method in accordance with claim 12, wherein step(d) causes the computer, in response to receipt of an update request of the product quote by selection of the update option selection element in the window after expiration of the valid period, to prepare an update quote including a delivery date based on the product information of the specified product.

14. An electronic quotation method in accordance with claim 12, wherein said step(d), in response to receipt of an update request of the product quote, reads a current status of a stock with respect to the specified product from said product information storage module, retrieves one or multiple substitute products, which are substitutable for the specified product, from said product information storage module when it is determined that there is no stock of the specified product, and creates a list of the one or multiple substitute products, instead of preparing the update quote, and
said step(e) sends the window including the list of the one or multiple substitute products, instead of the product quote, to the sender of the quotation request.

15. An electronic quotation method in accordance with claim 14, wherein the quotation request of the specified product includes specification of at least one component of the specified product,
said step(d), in response to receipt of an update request of the product quote, reads a current status of a stock with respect to the at least one specified component of the specified product from said product information storage module, retrieves one or multiple substitute components, which are substitutable for the at least one specified component of the specified product, from said product information storage module when it is determined that there is no stock of the at least one specified component of the specified product, and creates a list of the one or multiple substitute components, instead of preparing the update quote, and
said step(e) sends the window including the list of the one or multiple substitute components, instead of the at least one specified component of the specified product, to the sender of the quotation request.

16. An electronic quotation method in accordance with claim 12, wherein said step(d), in response to receipt of an update request of the product quote, reads a current status of a stock with respect to the specified product from said product information storage module, retrieves one or multiple substitute products, which are substitutable for the specified product, from said product information storage module when it is determined that there is no stock of the specified product, and creates a substitute product quote, based on product information of the one or multiple substitute products instead of creating the update quote, and
said step(e) sends the window including the substitute product quote, instead of the product quote, to the sender of the quotation request.

17. An electronic quotation method in accordance with claim 16, wherein the quotation request of the specified product includes specification of at least one component of the specified product,
said step(d), in response to receipt of an update request of the product quote, reads a current status of a stock with respect to the at least one specified component of the specified product from said product information storage module, retrieves one or multiple substitute components, which are substitutable for the at least one specified component of the specified product, from said product information storage module when it is determined that there is no stock of the at least one specified component of the specified product, and creates a substitute product quote, based on product information on the one or multiple substitute components, instead of creating the update quote.

18. An electronic quotation method in accordance with claim 11, wherein the quotation request of the specified product includes specification of at least one component of the specified product.

19. An electronic quotation method in accordance with claim 11, wherein said step(c) sends a specific program, in addition to the window, to the sender of the quotation request, said specific program causing a computer at the sender of the quotation request to execute a function of enabling the order option selection element as selectable when the product quote is still in the valid period and disabling the order option selection element as unselectable when the valid period of the product quote has expired.

20. A program that causes a computer to make a quote of a product specified by a client by utilizing a product information storage module that stores product information of the specified product, which is updated appropriately, said program causing the computer to attain the functions of:
(a) preparing a product quote, based on the product information of the specified product, in response to receipt of a quotation request of the specified product;
(b) setting a valid period of the product quote; and
(c) sending a window, which includes the product quote and an order option selection element selected by the client to order a specification of the product quote, to a sender of the quotation request in such a manner that the order option selection element is enabled as selectable when the product quote is in the valid period and the order option selection element is disabled as unselectable when the valid period of the product quote has expired.
